(19) United States
(12) Patent Application Publication
(10) Pub. No.: US 2026/0187062 A1
(43) Pub. Date: Jul. 2, 2026

(54) TOPIC-CATALOG-BASED LLM ASSISTANCE IN A DATABASE MANAGEMENT SYSTEM

(71) Applicant: Teradata US, Inc., San Diego, CA (US)

(72) Inventors: Andrew Tillo, Bothell, WA (US); Tam Le, San Diego, CA (US); John Douglas Frazier, Ramona, CA (US)

(73) Assignee: Teradata US, Inc., San Diego, CA (US)

(21) Appl. No.: 19/007,396

(22) Filed: Dec. 31, 2024

(51) Int. Cl. G06F 16/2452; G06F 16/2455; G06F 16/334

(52) U.S. Cl. CPC G06F 16/24522; G06F 16/3347; G06F 16/2455

(57) ABSTRACT

A system includes a storage device configured to store at least one database. The system includes a plurality of processing nodes in communication with the storage device. The plurality of processing nodes collects a subset of the data. The plurality of processing nodes generates a plurality of vectors using a vectorizing large language model (“LLM”) based on the subset of related data. The plurality of processing nodes stores the plurality of vectors. The plurality of processing nodes receives a natural language query from a LLM agent. The plurality of processing nodes vectorizes the natural language query. The plurality of processing nodes compares the vectorized natural language query to the plurality of vectors. The plurality of processing nodes generates a database-language query based on the comparison. The plurality of processing nodes executes the database language query. A method and computer-readable medium are also disclosed.

### BACKGROUND

Artificial intelligence (“AI”) has been rapidly introduced into database management systems to allow data to be queried on through natural language input. This requires AI techniques, such as large language models (“LLMs”) to be implemented to serve as a bridge between natural language input and database query language. One challenge in this bridging is being able to identify database data around that a natural language query (“NLQ”) requires in order to provide an accurate response. Simply querying over all data in a database can be non-starter due to the limitations of LLMs with regard to context and content. Instead, an LLM typically requires assistance in locating query data in a manner that is both timely and accurate.

Because traditional LLMs are require guidance, it would be desirable to develop topic-based content to allow LLMs to more efficiently handle queries.

### SUMMARY

According to one aspect of the disclosure, a system may include a storage device configured to store at least one database. The system may further include a plurality of processing nodes in communication with the storage device. The plurality of processing nodes may collect a subset of the data. The plurality of processing nodes may generate a plurality of vectors using a vectorizing large language model (“LLM”) based on the subset of related data.

The plurality of processing nodes may store the plurality of vectors. The plurality of processing nodes may receive a natural language query from a LLM agent. The plurality of processing nodes may vectorize the natural language query. The plurality of processing nodes may compare the vectorized natural language query to the plurality of vectors. The plurality of processing nodes may generate a database-language query based on the comparison. The plurality of processing nodes may execute the database language query.

According to another aspect of the disclosure, a method may include may collecting, with a processor, a subset of the data. The method may further include generating, with the processor, a plurality of vectors using a vectorizing LLM based on the subset of related data. The method may further include storing, with the processor, the plurality of vectors. The method may further include receiving, with the processor, a natural language query from a LLM agent. The method may further include vectorizing, with a processor, the natural language query. The method may further include comparing, with the processor, the vectorized natural language query to the plurality of vectors The method may further include generating, with the processor, a database-language query based on the comparison. The method may further include executing, with the processor, the database language query.

According to another of the disclosure, a computer-readable medium may be encoded with a plurality of instructions executable by a processor. The plurality of instruction may include instructions to collect a subset of the data. The plurality of instruction may include instructions to generate a plurality of vectors using a vectorizing LLM based on the subset of related data. The plurality of instruction may include instructions to store the plurality of vectors. The plurality of instruction may include instructions to receive a natural language query from a LLM agent. The plurality of instruction may include instructions to vectorize the natural language query. The plurality of instruction may include instructions to compare the vectorized natural language query to the plurality of vectors. The plurality of instruction may include instructions to generate a database-language query based on the comparison. The plurality of instruction may include instructions to execute the database language query.

### BRIEF DESCRIPTION OF THE DRAWINGS

The disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an example analytic environment.

FIG. 2 is a detailed block diagram of a processing node.

FIG. 3 is a detailed block diagram of an optimizer module.

FIG. 4 is a detailed block diagram of a parser module.

FIG. 5 is a block diagram of a topic catalog implemented by a database management system.

FIG. 6 is a block diagram of operation of a topic catalog.

FIG. 7 is a block diagram of enhancements to a topic catalog.

FIG. 8 is an operational flow diagram of example operation of a topic catalog.

### DETAILED DESCRIPTION OF THE FIGURES

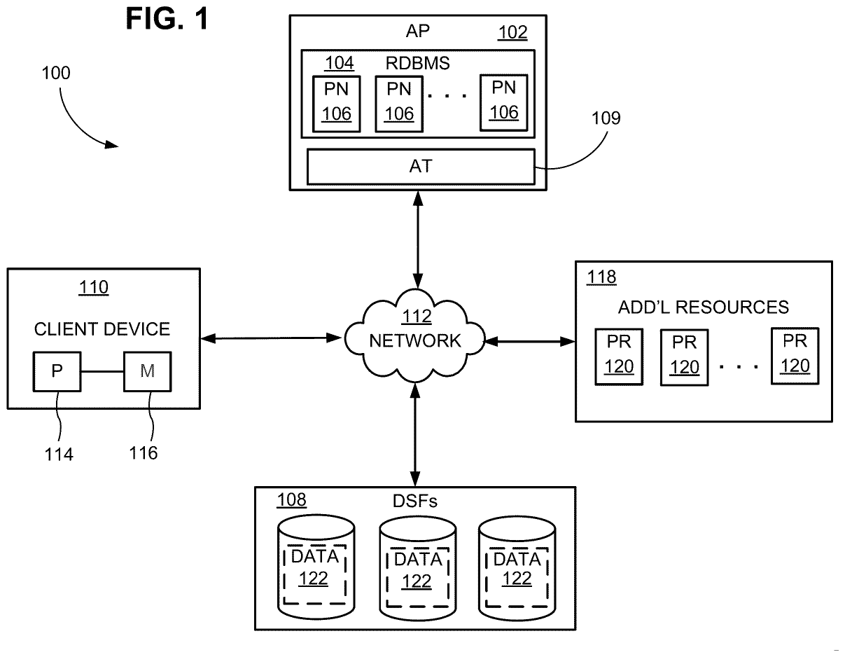

FIG. 1 is a block diagram of an example analytic environment 100. In one example, the analytic environment 100 may include an analytic platform (“AP”) 102, such as Teradata Vantage. The analytic platform 102 may include one or more systems that may be used independently or with one another in conducting advanced analytics. The analytic platform 102 may include a relational database management system (“RDBMS”) 104. In one example, the RDBMS 104 may implement a parallel-processing environment to conduct database management. The RDBMS 104 may be a combination of software (e.g., computer program routines, subroutines, applications, etc.) and hardware (e.g., processors, memory, etc.). In the example of FIG. 1, the RDBMS 104 may be a massively parallel processing (MPP) system having a number of processing nodes 106. In alternative examples, the RDBMS 104 may implement a single processing node, such as in a symmetric multiprocessing (SMP) system configuration. The RDBMS 104 may include one or more processing nodes 106 used to manage the storage, retrieval, and manipulation of data in data storage facilities (DSFs) 108. The DSFs 108 may represent various types of storage, such as persistent and/or non-persistent, for example. The processing nodes 106 may manage the storage, retrieval, and manipulation of data included in a database.

The analytic environment 100 may include a client device 110 that communicates with the analytic platform 102 via a network 112. The client device 110 may represent one or more devices, such as a graphical user interface (“GUI”), that allows user input to be received. The client device 110 may include one or more processors 114 and memory(ies) 116. The network 112 may be wired, wireless, or some combination thereof. The network 112 may be a cloud-based environment, virtual private network, web-based, directly-connected, and/or some other suitable network configuration. In one example, the client device 110 may run a dynamic workload manager (DWM) client (not shown).

The analytic environment 100 may also include additional resources 118. Additional resources 118 may include processing resources (“PR”) 120. In a cloud-based network environment, the additional resources 118 may represent additional processing resources that allow the analytic platform 102 to expand and contract processing capabilities as needed.

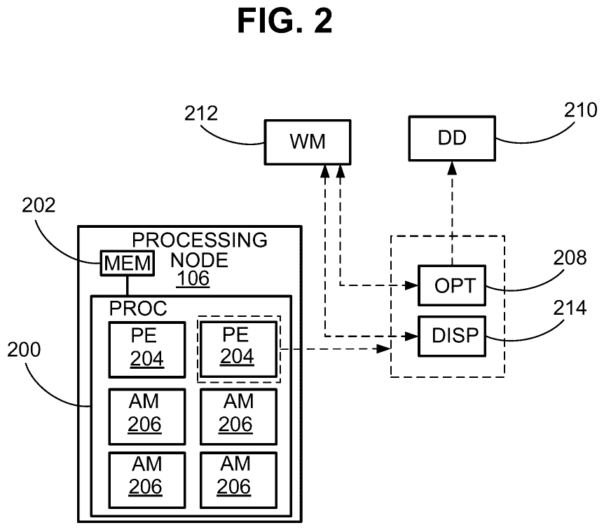

FIG. 2 is an example of a processing node 106, which may include one or more physical processors 200 and memory(ies) 202. Memory(ies) 202 may include one or more memories and may be computer-readable storage media or memories, such as a cache, buffer, random access memory (RAM), removable media, hard drive, flash drive or other computer-readable storage media. Computer-readable storage media may include various types of volatile and nonvolatile storage media. Various processing techniques may be implemented by the processors 200 such as multiprocessing, multitasking, parallel processing, and the like, for example.

The processing nodes 106 may include one or more other processing unit types such as parsing engine (PE) modules 204 and access modules (AM) 206. As described herein, each module, such as the parsing engine modules 204 and access modules 206, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the memory 202, for example, which includes instructions executable with the processor 200 or other processor to implement one or more of the features of the module. When any one of the modules includes the portion of the memory 202 that comprises instructions executable with the processor, the module may or may not include the processor. In some examples, each module may just be the portion of the memory 202 or other physical memory that comprises instructions executable with the processor 200 or other processor to implement the features of the corresponding module without the module including any other hardware. Because each module includes at least some hardware even when the included hardware comprises software, each module may be interchangeably referred to as a hardware module, such as the parsing engine hardware module or the access hardware module. The access modules 206 may be access modules processors (AMPs), such as those implemented in the Teradata Vantage analytic platform, for example.

The parsing engine modules 204 and the access modules 206 may each be virtual processors (vprocs) and/or physical processors. In the case of virtual processors, the parsing engine modules 204 and access modules 206 may be executed by one or more physical processors, such as those that may be included in the processing nodes 106. For example, in FIGS. 1-2, each parsing engine module 204 and access module 206 is associated with a respective processing node 106 and may each be executed as one or more virtual processors by physical processors 200 included in the respective processing node 106.

In FIG. 2, each processing node 106 is shown as including multiple parsing engine modules 204 and access modules 206, such that there are more parsing engine modules 204 and access modules 206 than processing nodes 106. In one example, during operation, the one or more physical processors 200 included in the processing nodes 106 may execute the parsing engine modules 204 and access modules 206 by switching between the executions of the various modules at a rapid rate allowing the vprocs to substantially operate in “parallel.”

The RDBMS 104 stores data 122 in one or more tables (or other data object formats) in the DSFs 108. In one example, the data 122 may represent rows of stored tables that are distributed across the DSFs 108 and in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to DSFs 108 and associated access modules 206 by a hash bucket map. The characteristics of the columns chosen for the primary index determine how evenly the rows are distributed.

Rows of each stored table may be stored across multiple DSFs 108. Each parsing engine module 204 may organize the storage of data and the distribution of table rows. The parsing engine modules 204 may also coordinate the retrieval of data from the DSFs 108 in response to queries received, such as those received from a client system 108 connected to the RDBMS 104 through connection with a network 112.

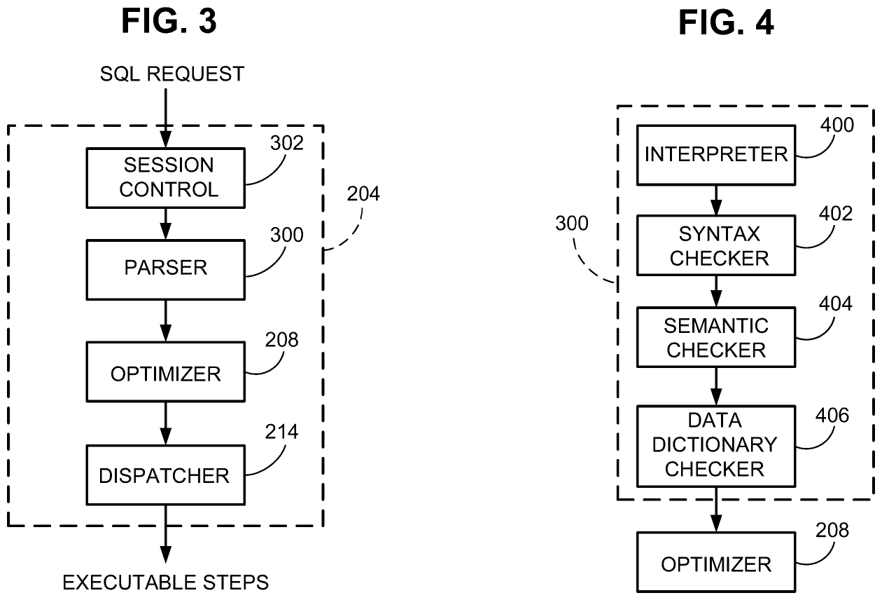

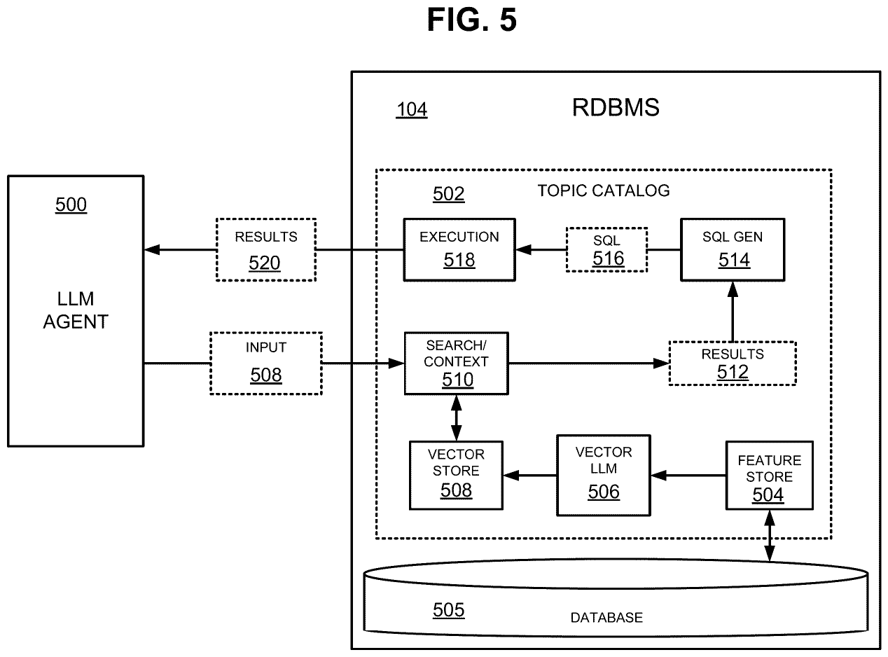

Each parsing engine module 204, upon receiving an incoming database query may apply an optimizer module 208 to assess the best plan for execution of the query. An example of an optimizer module 208 is shown in FIG. 2 with regard to a parsing engine module 204. Additional description of the parsing engine modules 204 is provided with regard to FIGS. 3 and 4. Selecting the optimal query-execution plan may include, among other things, identifying which of the processing nodes 106 are involved in executing the query and which database tables are involved in the query, as well as choosing which data-manipulation techniques will serve best in satisfying the conditions of the query. To this end, for each parsing engine module 204, a parser module 300 (see FIG. 3), and/or optimizer module 208 may access a data dictionary module 210, shown in FIG. 2 specifically for parsing engine module 204 for purposes of illustration.

The data dictionary module 210, which may reside in the RDBMS 104, may specify the organization, contents, and conventions of one or more databases, such as the names and descriptions of various tables maintained by the RDBMS 104 as well as fields/columns of each database, for example. Further, the data dictionary module 210 may specify the type, length, and/or other various characteristics of the stored tables. The RDBMS 104 typically receives queries in a standard format, such as the structured query language (SQL) put forth by the American National Standards Institute (ANSI). However, other languages and techniques, such as contextual query language (CQL), data mining extensions (DMX), and multidimensional expressions (MDX), graph queries, analytical queries, machine learning (ML), large language modes (LLM) and artificial intelligence (AI), for example, may be implemented in the RDBMS 104 separately or in conjunction with SQL. The data dictionary 210 may be stored in the DSFs 108 or some other storage device and selectively accessed.

The RDBMS 104 may include a workload management system workload management (WM) module 212, which may be executed within the RDBMS 104 by one or more processing nodes 106. The WM module 212 may be implemented as a “closed-loop” system management (CLSM) architecture capable of satisfying a set of workload-specific goals. In other words, the RDBMS 104 is a goal-oriented workload management system capable of supporting complex workloads and capable of self-adjusting to various types of workloads. The WM module 212 may communicate with each optimizer module 208, as shown in FIG. 2, and is adapted to convey a confidence threshold parameter and associated parameters to the optimizer module 208 in communication. Further, the WM module 212 may communicate with a dispatcher module 214 of each parsing engine module 206 (as shown in detail in FIG. 2 for parsing engine module 206) to receive query execution plan costs therefrom, and to facilitate query exception monitoring and automated modifications of confidence threshold parameters in accordance with disclosed embodiments.

The WM module 212 operation has four major phases: 1) assigning a set of incoming request characteristics to workload groups, assigning the workload groups to priority classes, and assigning goals (referred to as Service Level Goals or SLGs) to the workload groups; 2) monitoring the execution of the workload groups against their goals; 3) regulating (e.g. adjusting and managing) the workload flow and priorities to achieve the SLGs; and 4) correlating the results of the workload and taking action to improve performance. In accordance with disclosed embodiments, the WM module 212 is adapted to facilitate control of the optimizer module 208 pursuit of robustness with regard to workloads or queries.

An interconnection (not shown) allows communication to occur within and between each processing node 106. For example, implementation of the interconnection provides media within and between each processing node 106 allowing communication among the various processing units. Such communication among the processing units may include communication between parsing engine modules 204 associated with the same or different processing nodes 106, as well as communication between the parsing engine modules 204 and the access modules 206 associated with the same or different processing nodes 106. Through the interconnection, the access modules 206 may also communicate with one another within the same associated processing node 106 or other processing nodes 106.

The interconnection may be hardware, software, or some combination thereof. In instances of at least a partial-hardware implementation the interconnection, the hardware may exist separately from any hardware (e.g., processors, memory, physical wires, etc.) included in the processing nodes 106 or may use hardware common to the processing nodes 106. In instances of at least a partial-software implementation of the interconnection, the software may be stored and executed on one or more of the memories 202 and processors 200 of the processing nodes 106 or may be stored and executed on separate memories and processors that are in communication with the processing nodes 106. In one example, the interconnection may include multi-channel media such that if one channel ceases to properly function, another channel may be used. Additionally, or alternatively, more than one channel may also allow distributed communication to reduce the possibility of an undesired level of communication congestion among processing nodes 106.

In one example system, each parsing engine module 206 includes three primary components: a session control module 302, a parser module 300, and the dispatcher module 214 as shown in FIG. 3. The session control module 300 provides the logon and logoff functions. It accepts a request for authorization to access the database, verifies it, and then either allows or disallows the access. Once the session control module 302 allows a session to begin, a SQL request may be received such as through submission the client device 110 and the SQL request is routed to the parser module 300.

As illustrated in FIG. 4, the parser module 300 may include an interpreter module 400 that interprets the SQL request. The parser module 300 may also include a syntax checker module 402 that checks the request for correct SQL syntax, as well as a semantic checker module 404 that evaluates the request semantically. The parser module 302 may additionally include a data dictionary checker 406 to ensure that all of the objects specified in the SQL request exist and that the user has the authority to perform the request. The parsing engine module 206 implements the optimizer module 208 to select the least expensive plan to perform the request, and the dispatcher 214 coordinates the runtime execution of executable steps of the query execution plan of the optimizer module 208 with the access modules 206.

In one example, to facilitate implementations of automated adaptive query execution strategies, such as the examples described herein, the WM module 212 monitoring takes place by communicating with the dispatcher module 214 as it checks the query execution step responses from the access modules 206. The step responses include the actual cost information, which the dispatcher module 214 may then communicate to the WM module 212 which, in turn, compares the actual cost information with the estimated costs of the optimizer module 208.

AI-driven techniques have allowed the opportunity for database management systems to receive and process natural-language-based queries. However, this processing can be difficult due to the size of many databases. In one example, the RDBMS 104 may allow various topics to be established to allow natural language queries to be processed with increased accuracy. In particular, the topics may create contextualized meaning to the semantics of a natural-language query (“NLQ”).

In one example, an LLM agent 500 may be used in interact with the RDBMS 104. In order to accommodate NLQs via the LLM agent a topic catalog 502 may be configured to allow information on selected topics to be collected in order to optimize accuracy in responding to queries received via the LLM agent 500. The topic catalog 502 may include a feature store 504. The feature store 504 may represent a collection of data (i.e., tables and views) associated with a particular topic. The feature store 504 may be content-based or metadata-based. Content-based may contained data from table contents. Metadata-based may include metadata information about tables such as the table and column description. Contents of the feature store 504 may be extracted from a chosen database 505. The contents of the feature store 504 may be established a preprocessing step and may be altered as additional content is identified or prior content changes.

In one example, a prompt may be created to be delivered by the LLM agent 500 through and LLM session to provide guidance to a user. The prompt may be presented based in user-input identify a specific topic, which will connect the LLM session with an appropriate topic. The input may indicate a specific database to be queried or specific subjects. The prompt may provide multiple questions of frequently asked questions or may allow free-text input.

The topic catalog 500 may also include a vectorizing LLM 504 and a vector store 506. The contents of the feature store 502 may be vectorized by the vectorizing LLM 504 and the vector representations stored in the vector store 506. Input 508 received by the topic catalog 502 may be used by a search/content module 510 to search for relevant information in the vector store 508. A set of results 512 may be generated and provided to a SQL generation module 514. The SQL generation module 514 may generate SQL language representative of the results 512 and undergo execution 518 by the RDBMS 104, with the results 520 delivered to the LLM agent 500.

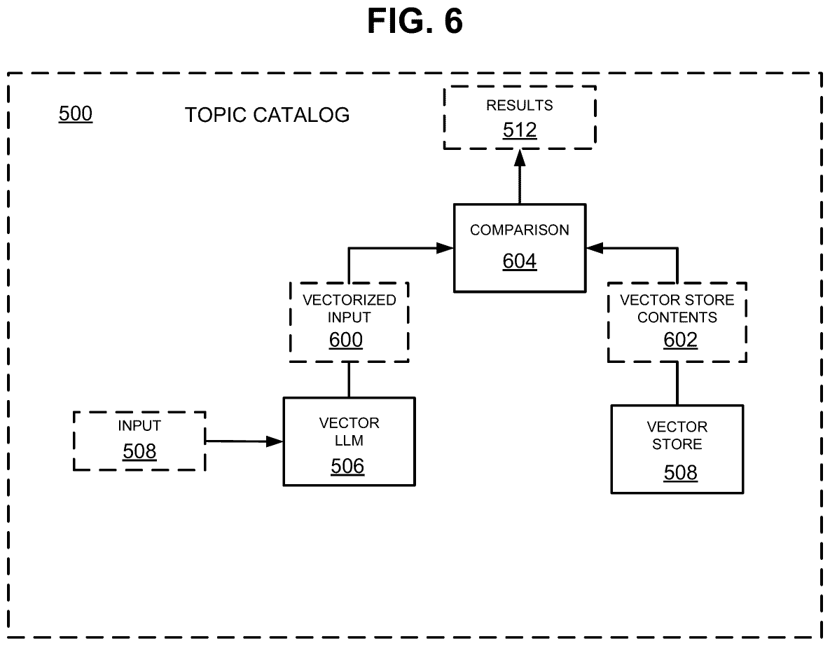

FIG. 6 is a detailed block diagram of an example of the results being generated. In one example, the input 508 may be vectorized using the vectorizing LLM 506. The vectorized input 600 and vector store contents 602 may undergo a comparison 604 to determine which vectors of the vector store content 604 are similar enough to be considered relevant to generate the results 512. Different algorithms may be used during the comparison 604, such as VECTORDISTANCE or KMEANS. A user may select the algorithm via the LLM agent 500. Additionally, a user may determine via the LLM agent 500 whether top k values or a threshold value is to be used in determining the vectors to be included in the results 512.

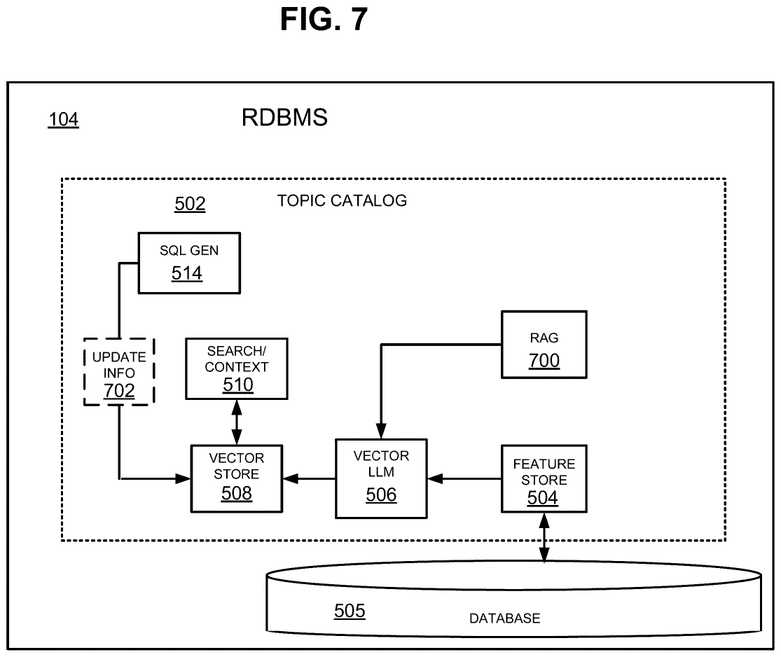

FIG. 7 is a block diagram of additional features used in the topic catalog 502 to enhance the precision of results generation. In one example, a retrieval augmented generation (“RAG”) module 700 may be used to identify additional information outside of a current feature store 504, which may be used to both update and supplement the feature store 504. The RAG module 700 may identify new data added to the database 505 or may identify information outside of the database depending on design choices.

Actions through the SQL generation module 514 may also be used to enhance the vector store 508 contents. The SQL generation module 514 may select specific results within the results 512. These actions may be provided to the vector store 508 as update information 702, which allows the vector store to be updated to indicate which particular results appear to be most accurate.

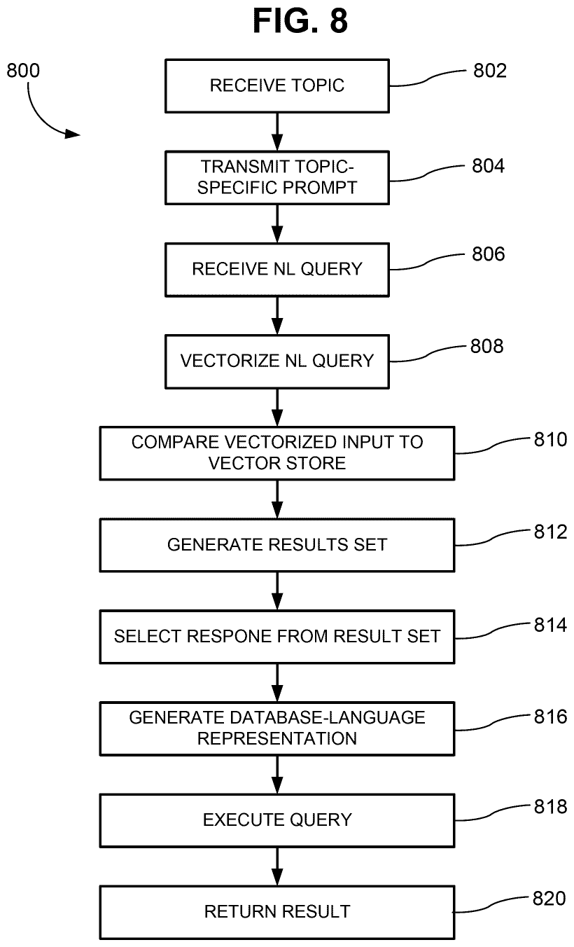

FIG. 8 is an operational flow diagram of example use of the topic catalog 502. In one example, the topic catalog 502 may receive a selected topic from the LLM agent 500 (802). The topic catalog 502 may transmit a topic-specific prompt to the LLM agent 500 (804). The topic catalog 502 may receive a natural language query (“NLQ”) based on the chosen topic (806). The received NLQ may be vectorized using the vectorizing LLM 506 (808). The vectorized NLQ may be compared to the contents of the vector store (810). As described, the comparisons can be made through various algorithms. The results set 512 may be generated from the comparison (812). The results set 512 may be generated based on top k values or a threshold level. The response may be selected from the results set 512 (814). A database-language representation of the selected response may be generated (816) and executed by the RDBMS (818). The results may be returned to the LLM agent 500.

While various embodiments of the disclosure have been described, it will be apparent to those of ordinary skill in the art that many more embodiments and implementations are possible within the scope of the disclosure. Accordingly, the disclosure is not to be restricted except in light of the attached claims and their equivalents.

1. A system comprising:
a storage device configured to store at least one database; and
a plurality of processing nodes in communication with the storage device, wherein the plurality of processing nodes is configured to:
collect a subset of data from the database, wherein the subset of data is collected based on a predetermined condition;
generate a plurality of vectors using a vectorizing large language model (“LLM”) using the subset of data, wherein the plurality of vectors represents the subset of data;
store the plurality of vectors;
receive a natural language query from an LLM agent;
vectorize the natural language query;
compare the vectorized natural language query to the plurality of vectors;
generate a database-language query based on the comparison; and
execute the database language query.

2. The system of claim 1, wherein the plurality of processing nodes is further configured to collect the subset of data from the database to establish a feature store.

3. The system of claim 2, wherein the feature store is content-based.

4. The system of claim 2, wherein the feature store is metadata-based.

5. The system of claim 1, wherein the plurality of processing nodes is further configured to execute a retrieval augmented generation (“RAG”) module, wherein the RAG module is configured to:
identify information not included in the feature store; and
update the feature store with the identified information.

6. A method comprising:
collecting, with a processor, a subset of data from a database based on a predetermined condition;
executing, with the processor, a vectorizing large language model (“LLM”), a plurality of vectors using a vectorizing large language model (“LLM”) using the subset of data, wherein the plurality of vectors represents the subset of data;
storing, with the processor, the plurality of vectors;
receiving, with the processor, a natural language query from an LLM agent;
vectorizing, with the processor, the natural language query;
comparing, with the processor, the vectorized natural language query to the plurality of vectors;
generating, with the processor, a database-language query based on the comparison; and
executing, with the processor, the database language query.

7. The method of claim 6 further comprising collecting, with the processor, the subset of data from the database to establish a feature store.

8. The method of claim 7, wherein the feature store is content-based.

9. The method of claim 7, wherein the feature store is metadata-based.

10. The method of claim 6 further comprising executing with the processor, a retrieval augmented generation (“RAG”) module, wherein the RAG module is configured to:
identify information not included in the feature store; and
update the feature store with the identified information.

11. A non-transitory computer-readable medium encoded with a plurality of instructions executable by a processor, the plurality of instructions comprising:
instructions to collect a subset of data from a database based on a predetermined condition;
instructions to generate a plurality of vectors using a vectorizing large language model (“LLM”) using the subset of data, wherein the plurality of vectors represents the subset of data;
instructions to store the plurality of vectors;
instructions to receive a natural language query from an LLM agent;
instructions to vectorize the natural language query;
instructions to compare the vectorized natural language query to the plurality of vectors;
instructions to generate a database-language query based on the comparison; and
instructions to execute the database language query.

12. The non-transitory computer-readable medium of claim 11, wherein the plurality of instructions further comprises instructions to collect the subset of data from the database to establish a feature store.

13. The non-transitory computer-readable medium of claim 12, wherein the feature store is content-based.

14. The non-transitory computer-readable medium of claim of claim 12, wherein the feature store is metadata-based.

15. The non-transitory computer-readable medium of claim 11, wherein the plurality of instructions further comprises instructions to execute a retrieval augmented generation (“RAG”) module, wherein the RAG module is configured to:
identify information not included in the feature store; and
update the feature store with the identified information.
